(19) United States
(12) Patent Application Publication
(10) Pub. No.: US 2010/0211591 A1
(43) Pub. Date: Aug. 19, 2010

(54) APPARATUS FOR PROCESSING STRINGS SIMULTANEOUSLY

(76) Inventors: Chuan-Hua Chang, Taipei City (TW); Chi-Chang Lai, Taichung County (TW); Hong-Men Su, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/371,908

(22) Filed: Feb. 16, 2009

(51) Int. Cl. G06F 17/30

(52) U.S. Cl. 707/769; 707/E17.039

(57) ABSTRACT

An exemplary string processing method for specific byte string processing with word-related instructions includes: loading a plurality of first predetermined strings; comparing a specific string with the loaded first predetermined strings simultaneously, thereby generating a plurality of comparison results corresponding to the specific string; and generating a string processing result according to the comparison results. A string processing apparatus uses the string processing method.

### BACKGROUND OF THE INVENTION

1. Field of the Invention

The present invention relates to string processing, and more particularly, to a string processing apparatus for processing a plurality of strings simultaneously.

2. Description of the Prior Art

String comparison is a frequently used function in string processing. For example, text searching, HTML/XML parsing, virus detection, and pattern matching are essential functions utilizing string comparison to achieve specific functions. The efficiency of string comparison greatly influences the overall performance of a string processing function. Conventional string comparison is implemented using byte-related instructions. That is, the system processes input strings once per byte.

Please refer to FIG. 11 in conjunction with FIG. 2. FIG. 1 is a diagram illustrating program codes and processor instructions of a function of executing “strcmp” (string comparison). FIG. 2 is an exemplary flowchart of the “strcmp” function accomplished using the processor instructions according to the prior art. The processor instructions included in an instruction group L1 are executed by a processor to implement a segment of program code “while (c1a !=‘\0’ && c1a==c1b)”, and a processor instruction included in an instruction group L2 is executed by the processor to implement a segment of program code “return c1a-c1b”. For those who are skilled in this field, it should be easily comprehended that the conventional string comparison illustrated in FIG. 1 is implemented once per byte, and four instructions (e.g., the processor instructions included in the instruction group L1 shown in FIG. 1) are required for processing one pair of bytes. For applications that require executing a lot of string comparison (e.g., HTML processing), the processing unit spends a considerable amount of time on comparing strings once per byte. In such cases, a more efficient string comparison method would facilitate the whole application process.

### SUMMARY OF THE INVENTION

In order to execute string comparison more efficiently, the present invention provides a string processing apparatus for processing a plurality of strings simultaneously.

In a first aspect of the present invention, an apparatus for string processing is disclosed. The apparatus includes: a first storage, storing a plurality of first predetermined strings; a second storage; a loading module, coupled to the first storage and the second storage, for loading the first predetermined strings from the first storage into the second storage; a comparing module, coupled to the second storage, for comparing a specific string with the first predetermined strings simultaneously, thereby generating a plurality of comparison results corresponding to the specific string; and a control logic, coupled to the comparing module, for generating a string processing result according to the comparison results.

In a second aspect of the present invention, an apparatus for string processing is provided. The apparatus includes: a first storage, storing a plurality of first predetermined strings; a second storage; a loading module, coupled to the first storage and the second storage, for loading the first predetermined strings from the first storage into the second storage; a comparing module, coupled to the second storage, for comparing the first predetermined strings with a plurality of second predetermined strings, respectively and simultaneously, to generate a plurality of comparison results corresponding to the second predetermined strings, respectively; and a control logic, coupled to the comparing module, for generating a string processing result according to the comparison results.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating program codes and processor instructions of a function used for executing “strcmp” (string comparison).

FIG. 2 is an exemplary flowchart of the “strcmp” function accomplished using the processor instructions according to the prior art.

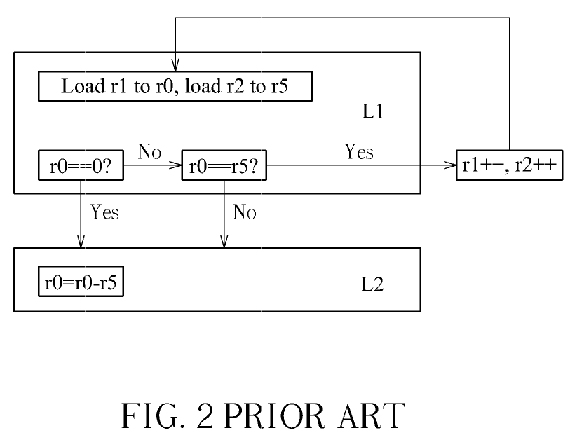

FIG. 3 is a flowchart illustrating a first exemplary embodiment of a string processing method according to the present invention.

FIG. 4 is a diagram illustrating a first exemplary embodiment of an apparatus for string processing according to the present invention.

FIG. 5 is a segment of pseudo codes for finding the first byte which is identical to a specific string constant.

FIG. 6 is a flowchart illustrating a second exemplary embodiment of a string processing method according to the present invention.

FIG. 7 is a diagram illustrating a second exemplary embodiment of an apparatus for string processing according to the present invention.

FIG. 8 is a segment of pseudo codes for finding the first byte which is identical to the initial byte of a loaded string.

FIG. 9 is a flowchart illustrating a third exemplary embodiment of a string processing method according to the present invention.

FIG. 10 is a diagram illustrating a third exemplary embodiment of an apparatus for string processing according to the present invention.

FIG. 11 is a segment of pseudo codes for finding the first mismatch between two words.

FIG. 12 is a segment of pseudo codes for finding the last mismatch between two words.

FIG. 13 is a flowchart illustrating a fourth exemplary embodiment of a string processing method according to the present invention.

FIG. 14 is a diagram illustrating a fourth exemplary embodiment of an apparatus for string processing according to the present invention.

FIG. 15 is a diagram illustrating program codes and processor instructions of a function of executing “strcmp” (string comparison) according to the present invention.

FIG. 16 is an exemplary flowchart of the “strcmp” function accomplished using the processor instructions according to the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

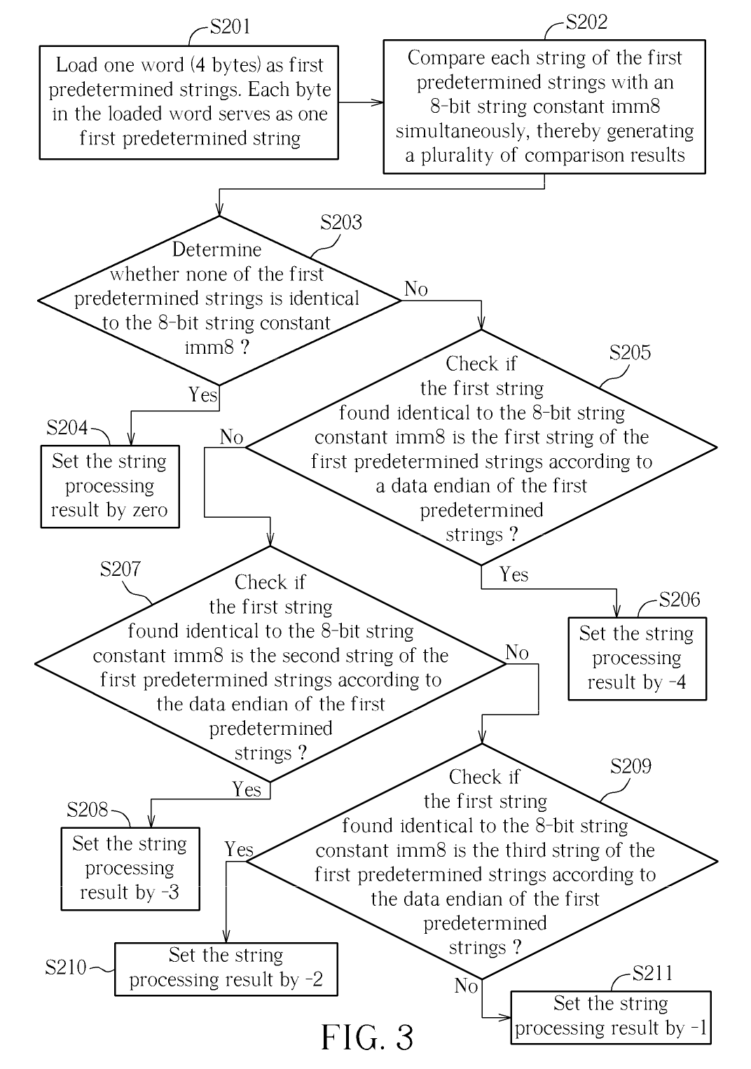

Please refer to FIG. 3. FIG. 3 is a flowchart illustrating a first exemplary embodiment of a string processing method according to the present invention. The main purpose of this exemplary embodiment is to find the first byte which is identical to a specific bit pattern. Provided that the result is substantially the same, the steps are not required to be executed in the exact order shown in FIG. 3. The first exemplary embodiment of the string processing method according to the present invention can be summarized as follows:

S201: Load one word (4 bytes) as first predetermined strings. Each byte in the loaded word serves as one first predetermined string.

S202: Compare each string of the first predetermined strings with an 8-bit string constant imm8 simultaneously, thereby generating a plurality of comparison results.

S203: Determine whether none of the first predetermined strings is identical to the 8-bit string constant imm8. If yes, go to step S204; otherwise, go to step S205.

S204: Set the string processing result to zero.

S205: Check if the first string found identical to the 8-bit string constant imm8 is the first string of the first predetermined strings according to a data endian of the first predetermined strings. If yes, go to step S206; otherwise, go to step 207.

S206: Set the string processing result to −4.

S207: Check if the first string found identical to the 8-bit string constant imm8 is the second string of the first predetermined strings according to the data endian of the first predetermined strings. If yes, go to step S208; otherwise, go to step S209.

S208: Set the string processing result to −3.

S209: Check if the first string found identical to the 8-bit string constant imm8 is the third string of the first predetermined strings according to the data endian of the first predetermined strings. If yes, go to step S210; otherwise, go to step 211.

S210: Set the string processing result to −2.

S211: Set the string processing result to −1.

In this embodiment, steps S205, S207, and S209 are configured to refer to the data endian of the first predetermined strings to find a first string from the first predetermined strings which is identical to the 8-bit string constant imm8.

Please note that actions in steps S206, S208, S210, and S211 indicate a sequence number of a string which is first found identical to the 8-bit string constant imm8 according to the data endian of the first predetermined strings; for instance, when the data endian of the first predetermined strings is little and only the string with the second smallest sequence number and the string with the third smallest sequence number are identical to the 8-bit string constant imm8 within the first predetermined strings. In this case, where the string number of the first predetermined strings is four, the final result of the string processing result is −3, which indicates that the first string found identical to the 8-bit string constant imm8 is 4−3=1, i.e., the string with the second smallest sequence number (since 0 is the indication of the smallest sequence number). In another case, the data endian of the first predetermined strings is big and only the string with the second smallest sequence number and the string with the third smallest sequence number are identical to the 8-bit string constant imm8 within the first predetermined strings. In this case, where the string number of the first predetermined strings is four, the final result of the string processing result is −2, which indicates that the first string found identical to the 8-bit string constant imm8 is 4−2=2, i.e., the string with the third smallest sequence number.

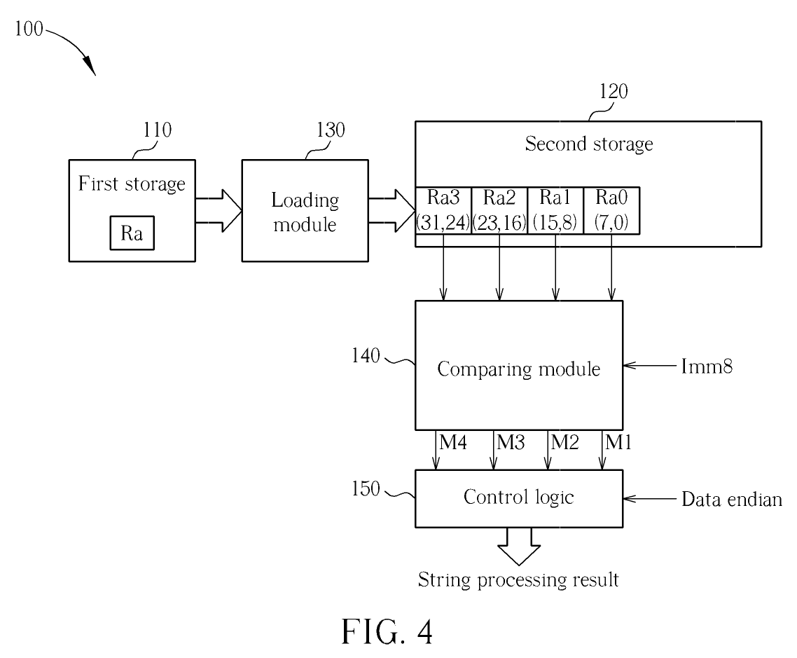

FIG. 4 is a diagram illustrating a first exemplary embodiment of an apparatus for string processing according to the present invention. The apparatus 100 is implemented to employ the method shown in FIG. 3 to find the first byte which is identical to a specific string constant. As illustrated in FIG. 4, the apparatus 100 comprises: a first storage 110 storing a word Ra, which comprises four bytes Ra0-Ra3 and data endian thereof is little; a second storage 120; a loading module 130, coupled to the first storage 110 and the second storage 120, for loading the word Ra from the first storage 110 into the second storage 120; a comparing module 140, coupled to the second storage 120, for comparing a string constant imm8 with the bytes Ra0-Ra3 within the loaded word Ra, respectively and simultaneously, thereby generating comparison results M1-M4 corresponding to the Ra0-Ra3 in the loaded word Ra; and a control logic 150, coupled to the comparing module 140, for generating a string processing result, which is indicative of the first byte identical to the string constant imm8 within the loaded word Ra, according to the comparison results M1-M4.

Furthermore, the control unit 150 sets the string processing result by a logic value to indicate the specific sequence number of a string which is first found identical to the string constant imm8 according to the data endian of the word Ra. In this embodiment, data endian of the word Ra is little for illustrative purposes. Assume only the string with the second smallest sequence number (i.e., Ra1) and the string with the third smallest sequence number (i.e., Ra2) is identical to the string constant imm8 within the word Ra. In this case, since there are four strings (i.e., Ra0-Ra3) in the word Ra, the control logic 150 sets the string processing result to −3 which indicates that the first string found identical to imm8 is 4−3=1, i.e., Ra1. On the other hand, when data endian of the word Ra is big, the control logic 150 will set the string processing result by −2 which indicates that the first string found identical to imm8 is 4−2=2, i.e., Ra2.

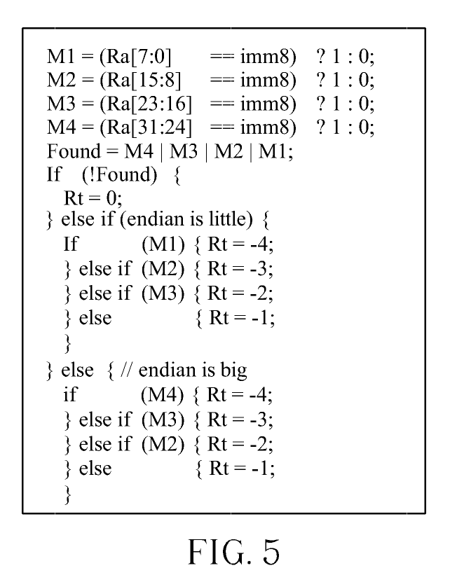

The operation of the aforementioned apparatus and method for finding the first byte which is identical to a specific string constant can be briefly summarized using pseudo codes shown in FIG. 5. As a person skilled in the pertinent art can readily understand details of the pseudo codes in FIG. 5 after reading the above paragraphs directed to the apparatus in FIG. 4 and the method in FIG. 3, further description is omitted here for the sake of brevity.

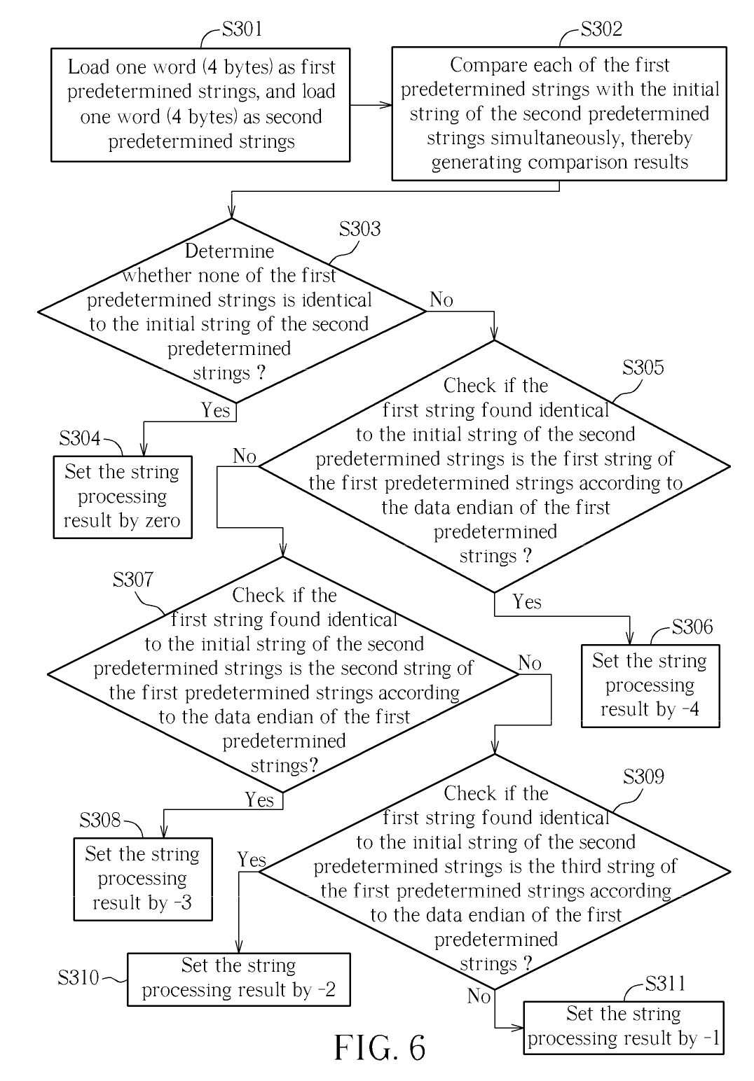

Please refer to FIG. 6. FIG. 6 is a flowchart illustrating a second exemplary embodiment of a string processing method according to the present invention. In this embodiment, a first byte which is identical to the initial byte of a loaded string is found. Provided that the result is substantially the same, the steps are not required to be executed in the exact order shown in FIG. 6. The second exemplary embodiment of the string processing method according to the present invention can be summarized as follows:

S301: Load one word (4 bytes) as first predetermined strings, and load one word (4 bytes) as second predetermined strings.

S302: Compare each of the first predetermined strings with the initial string of the second predetermined strings simultaneously, thereby generating comparison results.

S303: Determine whether none of the first predetermined strings is identical to the initial string of the second predetermined strings. if yes, go to step S304; otherwise, go to step S305.

S304: Set the string processing result to zero.

S305: Check if the first string found identical to the initial string of the second predetermined strings is the first string of the first predetermined strings according to the data endian of the first predetermined strings. If yes, go to step S306; otherwise, go to step S307.

S306: Set the string processing result to −4.

S307: Check if the first string found identical to the initial string of the second predetermined strings is the second string of the first predetermined strings according to the data endian of the first predetermined strings. If yes, go to step S308; otherwise, go to S309.

S308: Set the string processing result to −3.

S309: Check if the first string found identical to the initial string of the second predetermined strings is the third string of the first predetermined strings according to the data endian of the first predetermined strings. If yes, go to step S310; otherwise, go to step S311.

S310: Set the string processing result to −2.

S311: Set the string processing result to −1.

In this embodiment, steps S305, S307, and S309 are configured to refer to a data endian of the first predetermined strings to find a first string from the first predetermined string which is identical to the initial string of the second predetermined strings. In addition, as a person skilled in the art can readily understand the principle of setting the string processing result after reading the above paragraphs directed to the first exemplary embodiment of the string processing method, further description is omitted here for the sake of brevity.

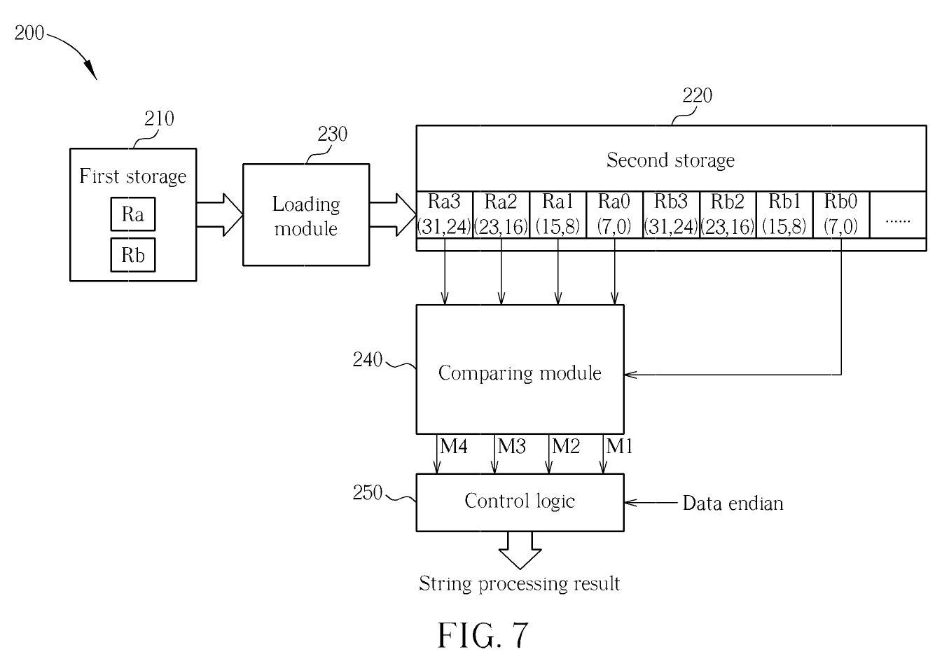

FIG. 7 is a diagram illustrating a second exemplary embodiment of an apparatus for string processing according to the present invention. The apparatus 200 is implemented to employ the method shown in FIG. 6 to find the first byte which is identical to the initial byte of a loaded string. In this embodiment, a second word Rb, which comprises Rb0-Rb3 and data endian thereof is little, is loaded from the first storage 210 to the second storage 220 via the loading module 230, and the initial string Rb0 is utilized by the comparing module 240 to generate comparison results M1-M4 corresponding to the Ra0-Ra3 within the loaded word Ra. Therefore, the control unit 250 is able to generate a string processing result indicative of the first byte identical to the initial byte of the second word Rb within the loaded word Ra.

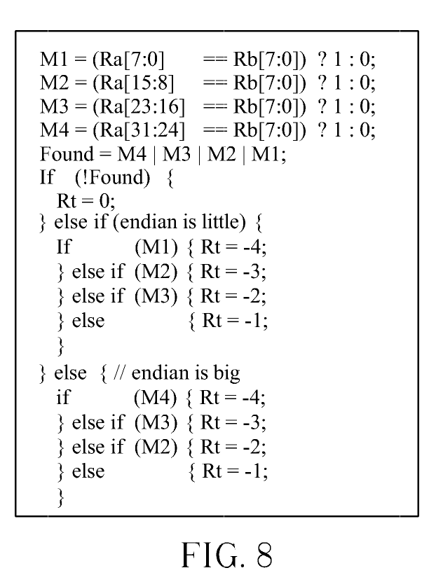

The operation of the aforementioned apparatus and method for finding the first byte which is identical to the initial byte of a loaded string can be briefly summarized using pseudo codes shown in FIG. 8. As a person skilled in the pertinent art can readily understand details of the pseudo codes in FIG. 8 after reading the above paragraphs directed to the apparatus in FIG. 7 and the method in FIG. 6, further description is omitted here for the sake of brevity.

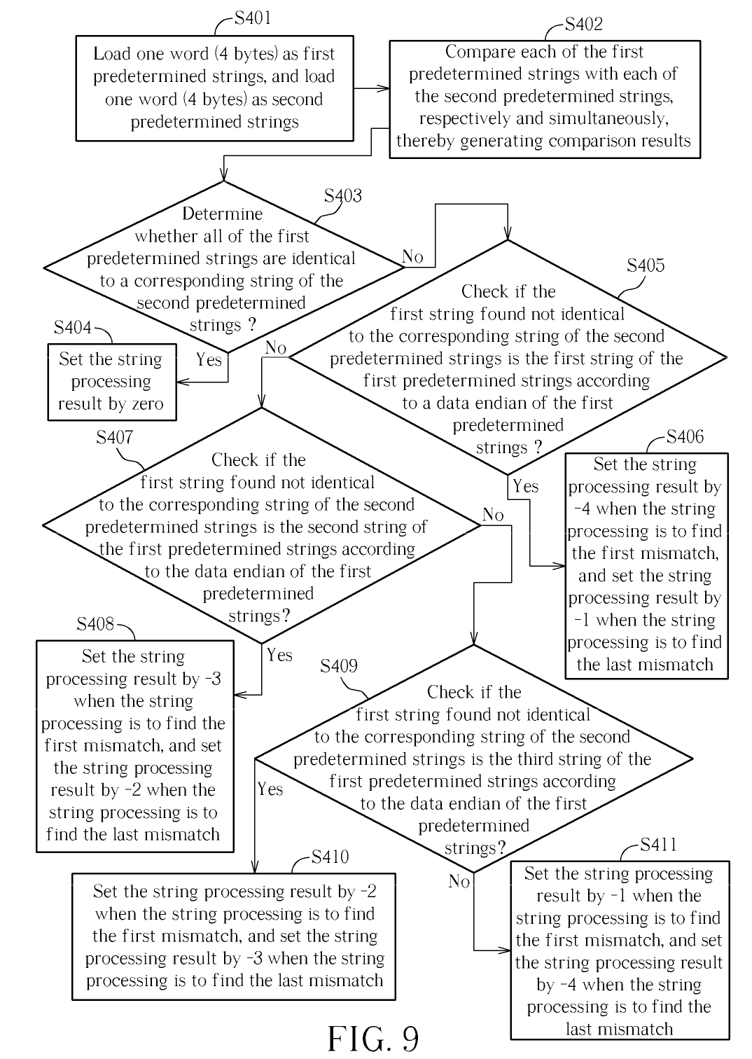

Please refer to FIG. 9. FIG. 9 is a flowchart illustrating a third exemplary embodiment of a string processing method according to the present invention. The objective of this embodiment is to find the first/last mismatch between two predetermined strings. Provided that the result is substantially the same, the steps are not required to be executed in the exact order shown in FIG. 9. The third exemplary embodiment of the string processing method according to the present invention can be summarized as follows:

S401: Load one word (4 bytes) as first predetermined strings, and load one word (4 bytes) as second predetermined strings.

S402: Compare each of the first predetermined strings with each of the second predetermined strings, respectively and simultaneously, thereby generating comparison results.

S403: Determine whether all of the first predetermined strings are identical to a corresponding string of the second predetermined strings. If yes, go to step S404; otherwise go to step S405.

S404: Set the string processing result to zero.

S405: Check if the first string found not identical to the corresponding string of the second predetermined strings is the first string of the first predetermined strings according to a data endian of the first predetermined strings. If yes, go to step S406; otherwise go to step S407.

S406: Set the string processing result to −4 when the string processing is to find the first mismatch, and set the string processing result to −1 when the string processing is to find the last mismatch.

S407: Check if the first string found not identical to the corresponding string of the second predetermined strings is the second string of the first predetermined strings according to the data endian of the first predetermined strings. If yes, go to step S408; otherwise go to step S409.

S408: Set the string processing result to −3 when the string processing is to find the first mismatch, and set the string processing result to −2 when the string processing is to find the last mismatch.

S409: Check if the first string found not identical to the corresponding string of the second predetermined strings is the third string of the first predetermined strings according to the data endian of the first predetermined strings. If yes, go to step S410; otherwise go to step S411.

S410: Set the string processing result to −2 when the string processing is to find the first mismatch, and set the string processing result to −3 when the string processing is to find the last mismatch.

S411: Set the string processing result to −1 when the string processing is to find the first mismatch, and set the string processing result to −4 when the string processing is to find the last mismatch.

In this embodiment, steps S405, S407, and S409 are configured to refer to the data endian of the first predetermined strings to find a first/last string from the first predetermined string which is not identical to the corresponding string of the second predetermined strings. In addition, as a person skilled in the art can readily understand the principle of setting the string processing result after reading the above paragraphs directed to the first exemplary embodiment of the string processing method, further description is omitted here for the sake of brevity.

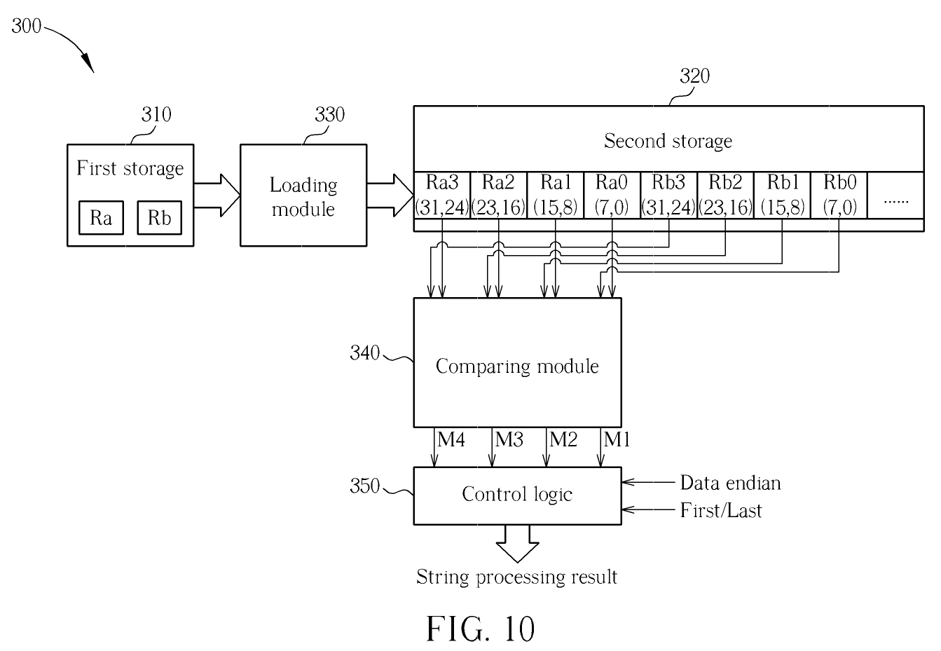

FIG. 10 is a diagram illustrating a third exemplary embodiment of an apparatus for string processing according to the present invention. The apparatus 300 is implemented to find the first/last mismatch between two words according to the method shown in FIG. 9. As illustrated in FIG. 10, the apparatus 300 comprises: a first storage 310, storing a plurality of words Ra and Rb, in which Ra comprises four bytes Ra0-Ra3 and data endian thereof is little, and Rb comprises four bytes Rb0-Rb3 and data endian thereof is little; a second storage 320; a loading module 330, coupled to the first storage 310 and the second storage 320, for loading the words Ra and Rb from the first storage 310 into the second storage 320; a comparing module 340, coupled to the second storage 320, for comparing Ra0-Ra3 within the word Ra and Rb0-Rb3 within the word Rb, respectively and simultaneously, to generate a plurality of comparison results M1-M4 corresponding to Ra0-Ra3 within the word Ra, respectively; and a control logic 350, coupled to the comparing module 340, for generating a string processing result, which is indicative of the first/last mismatch between the first word Ra and the second word Rb, according to the comparison results M1-M4.

In this embodiment, data endians of the words Ra and Rb are both little. Assume only the strings with the second smallest sequence number (i.e., Ra1 and Rb1) and the strings with the third smallest sequence number (i.e., Ra2 and Rb2) are mismatched. In this case, when the objective is to find the first mismatch, since there are four strings (i.e., Ra0-Ra3 and Rb0-Rb3) in the words Ra and Rb, respectively, the control logic 350 sets the string processing result to −3 which indicates that the first mismatch is 4−3=1, i.e., Ra1 and Rb1. However, when the objective is to find the last mismatch, the control logic 350 sets the string processing result to −2 which indicates that the first mismatch is 4−2=2, i.e., Ra2 and Rb2.

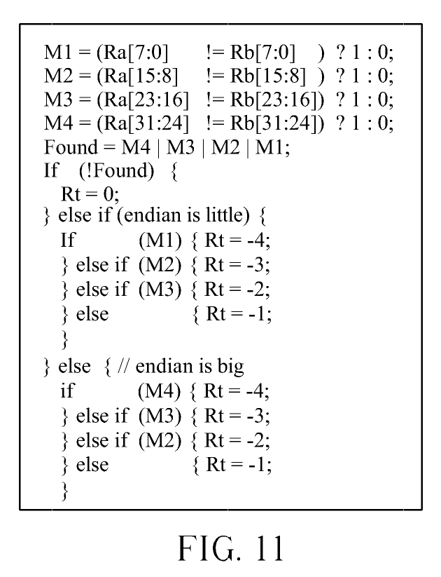

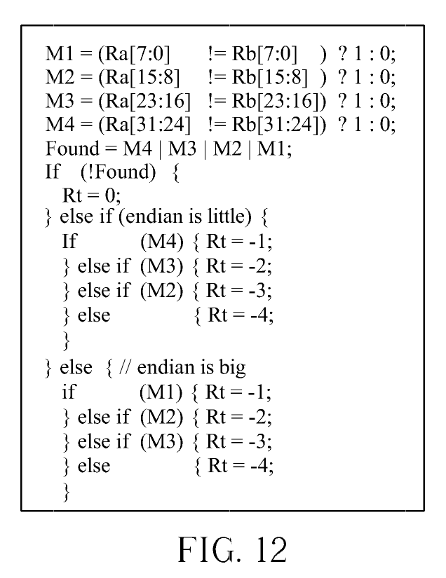

The operations of the aforementioned apparatus and method for finding the first and last mismatch between two words can be briefly summarized using pseudo codes shown in FIG. 11 and FIG. 12, respectively. As a person skilled in the pertinent art can readily understand details of the pseudo codes in FIG. 11 and FIG. 12 after reading the above paragraphs directed to the apparatus in FIG. 10 and the method in FIG. 9, further description is omitted here for the sake of brevity.

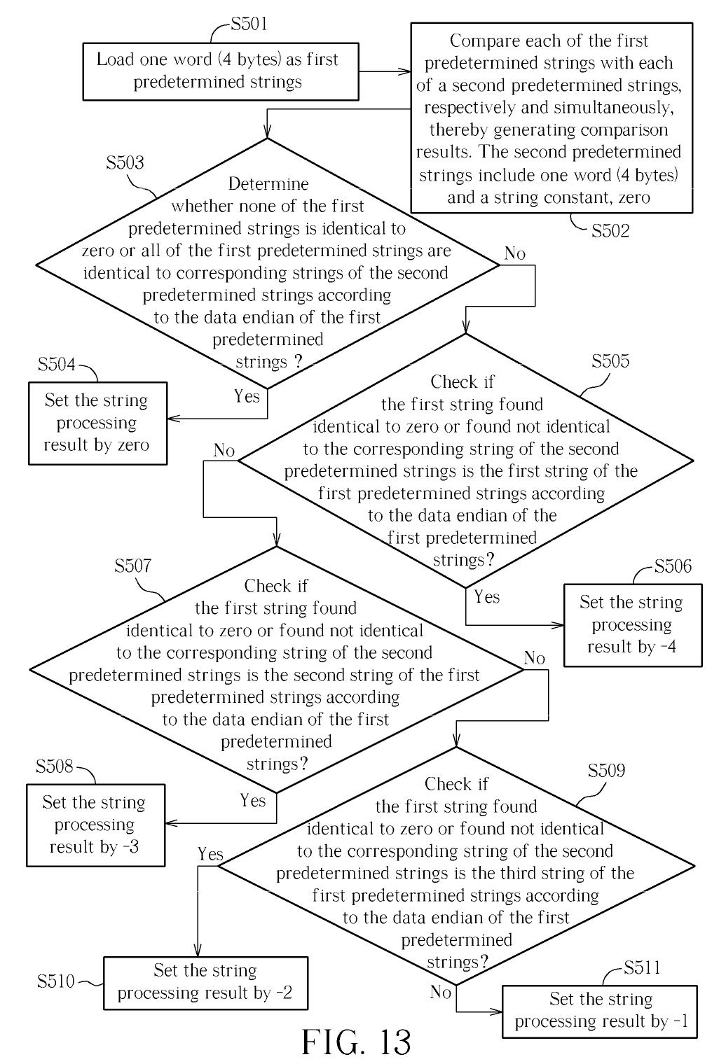

Please refer to FIG. 13. FIG. 13 is a flowchart illustrating a fourth exemplary embodiment of a string processing method according to the present invention. The main purpose of this embodiment is to find a first string from a first predetermined string which is identical to zero or is not identical to a corresponding string of a second predetermined strings. Provided that the result is substantially the same, the steps are not required to be executed in the exact order shown in FIG. 13. The fourth exemplary embodiment of the string processing method according to the present invention can be summarized as follows:

S501: Load one word (4 bytes) as first predetermined strings.

S502: Compare each of the first predetermined strings with each of second predetermined strings, respectively and simultaneously, thereby generating comparison results. The second predetermined strings include one word (4 bytes) and a string constant, zero.

S503: Determine whether none of the first predetermined strings is identical to zero or all of the first predetermined strings are identical to corresponding strings of the second predetermined strings according to the data endian of the first predetermined strings. If yes, go to step S504; otherwise, go to step S505.

S504: Set the string processing result to zero.

S505: Check if the first string found identical to zero or found not identical to the corresponding string of the second predetermined strings is the first string of the first predetermined strings according to the data endian of the first predetermined strings. If yes, go to step S506; otherwise go to step S507

S506: Set the string processing result to −4.

S507: Check if the first string found identical to zero or found not identical to the corresponding string of the second predetermined strings is the second string of the first predetermined strings according to the data endian of the first predetermined strings. If yes, go to step S508; otherwise go to step S509.

S508: Set the string processing result to −3.

S509: Check if the first string found identical to zero or found not identical to the corresponding string of the second predetermined strings is the third string of the first predetermined strings according to the data endian of the first predetermined strings. If yes, go to step S510; otherwise go to step S511.

S510: Set the string processing result to −2.

S511: Set the string processing result to −1.

In this embodiment, steps S505, S507, and S509 are configured to refer to a data endian of the first predetermined strings to find a first string from the first predetermined string which is identical to zero or is not identical to the corresponding string of the second predetermined strings. In addition, as a person skilled in the art can readily understand the principle of setting the string processing result after reading the above paragraphs directed to the first exemplary embodiment of the string processing method, further description is omitted here for the sake of brevity.

It should be noted that the aforementioned examples are for illustrative purposes only, and are not meant to be limitations of the application. For example, those skilled in the pertinent art should readily comprehend that the final string processing result can be set to any convenient number, e.g. 1-4, depending on the design requirements. Further description of these alternative designs obeying the spirit of the present invention is therefore omitted here for the sake of brevity.

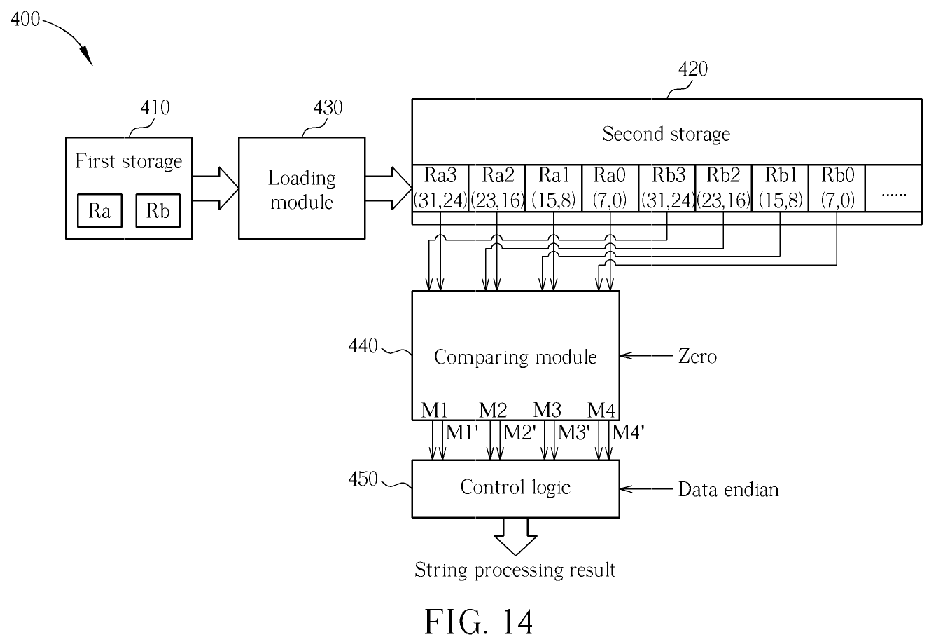

FIG. 14 is a diagram illustrating a fourth exemplary embodiment of an apparatus for string processing according to the present invention. The apparatus 400 is implemented to find a first zero in a first word Ra or a first mismatch between the first word Ra and the second word Rb. As illustrated in FIG. 14, besides the loaded word Rb, a zero string constant is set as an input for the comparing module 140 to generate comparison results M1′-M4′, which result from comparing each string Ra0, Ra1, Ra2, Ra3 of the first word Ra with the inputted zero string constant and comparing strings Ra0-Ra3 of the first word Ra with respective strings Rb0-Rb3 of the second word Rb. Therefore, the controlling unit 450 processes the comparison results M1-M4 and M1′-M4′ to generate a string processing result indicative of the first zero in the first word Ra or a first mismatch between the first word Ra and the second word Rb.

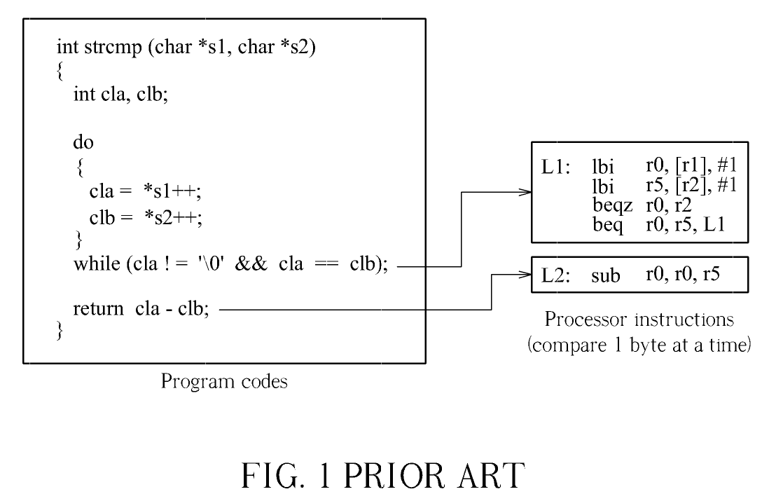

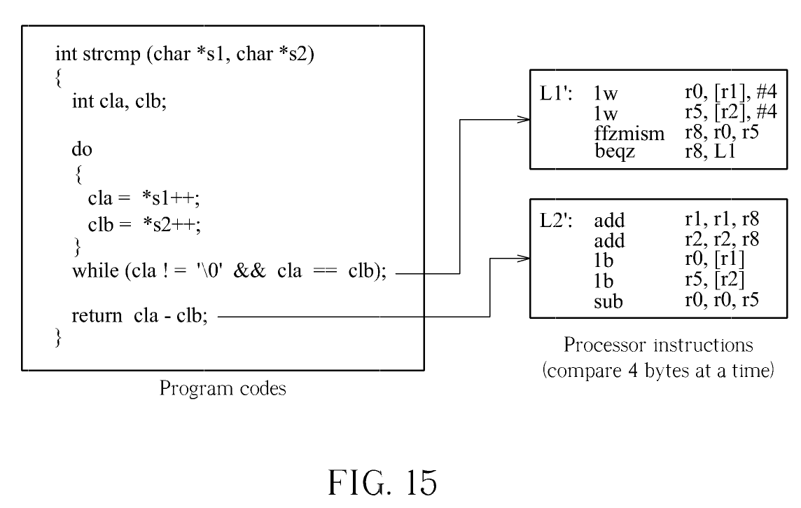

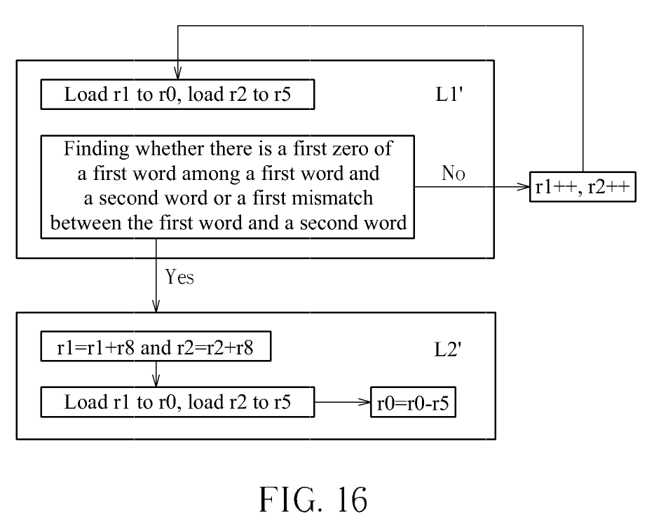

In summary, in accordance with the present invention, a string processing method and apparatus process a plurality of bytes (strings) among a word, simultaneously and respectively. In this way, each string is processed more efficiently. Please refer to FIG. 15 in conjunction with FIG. 16. FIG. 15 is a diagram illustrating program codes and processor instructions of a function of executing “strcmp” (string comparison) according to the present invention. FIG. 16 is an exemplary flowchart of the “strcmp” function accomplished using the processor instructions. The processor instructions included in an instruction group L1′ are executed by a processor to implement a segment of program code “while (c1a !=‘\0’ && c1a==c1b)”, and a processor instruction included in an instruction group L2′ is executed by the processor to implement a segment of program code “return c1a-c1b”. The aforementioned function “strcmp” can be implemented with the exemplary apparatus 400 shown in FIG. 14 to find a first zero in a first word or a first mismatch between the first word and the second word. As shown in FIG. 15, only one instruction is required per byte to realize the “strcmp” function, whereas the conventional method, as shown in FIG. 1, requires four instructions per byte. A great amount of time can be saved for processing strings according to the present invention.

Those skilled in the art will readily observe that numerous modifications and alterations of the device and method may be made while retaining the teachings of the invention.

What is claimed is:

1. An apparatus for string processing, comprising:
a first storage, storing a plurality of first predetermined strings;
a second storage;
a loading module, coupled to the first storage and the second storage, for loading the first predetermined strings from the first storage into the second storage;
a comparing module, coupled to the second storage, for comparing a specific string with the first predetermined strings simultaneously, thereby generating a plurality of comparison results corresponding to the specific string; and
a control logic, coupled to the comparing module, for generating a string processing result according to the comparison results.

2. The apparatus of claim 1, wherein the specific string is a string constant.

3. The apparatus of claim 1, wherein the loading module further loads a plurality of second predetermined strings from the first storage into the second storage, wherein one of the second predetermined strings loaded in the second storage is selected as the specific string.

4. The apparatus of claim 3, wherein the specific string is an initial string of the second predetermined strings.

5. The apparatus of claim 1, wherein the control logic refers to the comparison results to detect whether the specific string is identical to at least one of the loaded first predetermined strings to generate a detection result, and sets the string processing result according to the detection result.

6. The apparatus of claim 5, wherein when the detection result indicates that none of the loaded first predetermined strings is identical to the specific string, the control logic sets the string processing result to a first logic value; and when the detection result indicates that specific string is identical to at least one of the loaded first predetermined strings, the control logic refers to a data endian of the loaded first predetermined strings to find a first string from the loaded first predetermined string which is identical to the specific string, determines a second logic value corresponding to the first string, and sets the string processing result to the second logic value.

7. The apparatus of claim 6, wherein the control logic sets the second logic value according to an order of the first string which is identical to the specific string in the loaded first predetermined strings.

8. The apparatus of claim 1, wherein each of the first predetermined strings and the specific string is one element of a string.

9. The apparatus of claim 8, wherein the element of a string is a byte.

10. An apparatus for string processing, comprising:
a first storage, storing a plurality of first predetermined strings;
a second storage;
a loading module, coupled to the first storage and the second storage, for loading the first predetermined strings from the first storage into the second storage;
a comparing module, coupled to the second storage, for comparing the first predetermined strings with a plurality of second predetermined strings, respectively and simultaneously, to generate a plurality of comparison results corresponding to the second predetermined strings, respectively; and
a control logic, coupled to the comparing module, for generating a string processing result according to the comparison results.

11. The apparatus of claim 10, wherein the second predetermined strings comprise a string constant and a plurality of loaded strings loaded from the first storage by the loading module, and a number of the loaded strings is equal to the number of the first predetermined strings.

12. The apparatus of claim 11, wherein the control logic refers to the comparison results to detect whether at least one of the loaded first predetermined strings is identical to the string constant or is not identical to a corresponding loaded string of the second predetermined strings to generate a detection result, and sets the string processing result according to the detection result.

13. The apparatus of claim 12, wherein when the detection result indicates that each of the first predetermined strings is not identical to the string constant and is identical to a corresponding loaded string of the second predetermined strings, the control logic sets the string processing result to a first logic value; when the detection result indicates that at least one of the first predetermined strings is identical to the string constant or is not identical to the corresponding loaded string of the second predetermined strings, the control logic refers to a data endian of the first predetermined strings to find a first string from the first predetermined string which is identical to the string constant or is not identical to a corresponding loaded string of the second predetermined strings, determines a second logic value corresponding to the first string, and sets the string processing result to the second logic value.

14. The apparatus of claim 13, wherein the control logic sets the second logic value according to an order of the first string which is identical to the string constant or is not identical to a corresponding loaded string of the second predetermined strings in the first predetermined strings.

15. The apparatus of claim 10, wherein the loading module further loads the second predetermined strings from the first storage into the second storage, and a number of the first predetermined strings is equal to a number of the second predetermined strings.

16. The apparatus of claim 15, wherein the control logic refers to the comparison results to detect whether at least one of the loaded first predetermined strings is not identical to a corresponding second predetermined string to generate a detection result, and sets the string processing result according to the detection result.

17. The apparatus of claim 16, wherein when the detection result indicates that each of the loaded first predetermined strings is identical to a corresponding loaded second predetermined strings, the control logic sets the string processing result to a first logic value; and when the detection result indicates that at least one of the loaded first predetermined strings is not identical to the corresponding loaded second predetermined string, the control logic refers to a data endian of the first predetermined strings to find a first string from the first predetermined string which is identical to a corresponding second predetermined string, determines a second logic value corresponding to the first string, and sets the string processing result to the second logic value.

18. The apparatus of claim 17, wherein the control logic sets the second logic value according to an order of the first string in the loaded first predetermined strings.

19. The apparatus of claim 10, wherein each of the first predetermined strings and the second predetermined strings is one element of a string.

20. The apparatus of claim 19, wherein the element of a string is a byte.
